(19) United States
(12) Patent Application Publication
(10) Pub. No.: US 2021/0130604 A1
(43) Pub. Date: May 6, 2021

(54) COMPOSITIONS FOR USE IN SELECTIVE LASER SINTERING AND OTHER ADDITIVE MANUFACTURING PROCESSES

(71) Applicant: SABIC GLOBAL TECHNOLOGIES B.V., Bergen op Zoom (NL)

(72) Inventors: Vaidyanath RAMAKRISHNAN, Bergen Op Zoom (NL); Bruke JOFORE, Bergen Op Zoom (NL); Johannes Gerardus Petrus GOOSSENS, Heeswijk-Dinther (NL); Hao GU, Bergen Op Zoom (NL); Johannes Martinus Dina GOOSSENS, Bergen Op Zoom (NL)

(21) Appl. No.: 16/473,725

(22) PCT Filed: Dec. 27, 2017
(86) PCT No.: PCT/IB2017/058423

§ 371 Date: Jun. 26, 2019

Related U.S. Application Data
(60) Provisional application No. 62/439,225, filed on Dec. 27, 2016.

(51) Int. Cl. C08L 67/02; B33Y 70/10

(52) U.S. Cl. CPC C08L 67/02; B29K 2067/006; B33Y 70/10

(57) ABSTRACT

Provided are particulate compositions that include a matrix polymer and fibrillated reinforcement materials (e.g., PTFE or ultra-high molecular weight polyethylene fibrils) dispersed therein. The compositions are suitable for use in additive manufacturing processes.

### TECHNICAL FIELD

The present disclosure relates to the field of fibrillated polymeric materials and to the field of additive manufacturing.

### BACKGROUND

Additive-manufactured articles formed from pure resins suffer in some cases from anisotropic mechanical properties and other structural shortcomings, including poor adhesion between adjacent layers of such materials. Accordingly, there is a long-felt need in the art for improved compositions for use in additive manufacturing processes as well as related methods.

### SUMMARY

The present disclosure addresses the use of reinforcement materials (e.g., fibrillated fluoropolymers such as fibrillated PTFE and fibrillated ultra-high molecular weight polyethylene (UHMW-PE)) to reinforce a thermoplastic matrix for additive manufacturing applications. As one example, fibrillated fluoropolymer-reinforced resins may be used in particulate compositions, as a formulation of fluoropolymer in a resin matrix yields a material (and additively-manufactured goods) with enhanced properties.

In one aspect, the present disclosure provides particulate compositions, comprising: a population of polymeric particles comprising a thermoplastic matrix polymer and a plurality of fibrillated reinforcement material regions dispersed within the thermoplastic matrix polymer, the fibrillated reinforcement material being present in the particulate composition at from about 0.01 wt % to about 10 wt % as measured against the weight of the particulate composition, the population of polymeric particles having a number average diameter in the range of from about 10 micrometers (μm) to about 150 μm, and the melting temperature or Tg of the thermoplastic matrix polymer, whichever is higher, being below the melting temperature or Tg, whichever is lower, of the fibrillated reinforcement material.

Also provided are methods, comprising: additively manufacturing at least a portion of an article, using a particulate composition according to the present disclosure.

Further provided are additive-manufactured articles, comprising a plurality of layers, the layers being formed from a composition according to the present disclosure.

### BRIEF DESCRIPTION OF THE DRAWING

The following is a brief description of the drawings wherein like elements are numbered alike and which are exemplary of the various aspects described herein.

FIG. 1 provides exemplary impact strength (unnotched Izod) results for fibril-containing materials made according to the present disclosure.

FIG. 2 provides exemplary impact strength (unnotched Izod) results for fibril-containing materials made according to the present disclosure.

### DETAILED DESCRIPTION OF ILLUSTRATIVE ASPECTS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise. As used in the specification and in the claims, the term “comprising” may include the aspects “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps. It is to be understood that the terminology used herein is for the purpose of describing particular aspects only and is not intended to be limiting. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

Numerical values in the specification and claims of this application, particularly as they relate to polymers or polymer compositions, reflect average values for a composition that may contain individual polymers of different characteristics. Furthermore, unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams (g) to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1. Other meanings of “about” may be apparent from the context, such as rounding off, so, for example “about 1” may also mean from 0.5 to 1.4.

As used herein, “Tm” refers to the melting point at which a polymer completely loses its orderly arrangement. As used herein, “Tc” refers to the crystallization temperature at which a polymer gives off heat to form a crystalline arrangement. The terms “Glass Transition Temperature” or “Tg” may be measured by e.g. using a differential scanning calorimetry method and are expressed in degrees Celsius.

As used herein, “matrix polymer component” refers to one or more polymers that are not fibrillated. Examples of suitable matrix polymers include, but are not limited to, amorphous, crystalline, and semi-crystalline thermoplastic materials such as polyolefins (for example, linear or cyclic polyolefins such as polyethylene, chlorinated polyethylene, polypropylene, and the like); polyesters (for example, polyethylene terephthalate, polybutylene terephthalate, polycyclohexylmethylene terephthalate, and the like); arylate esters; polyamides; polysulfones (including hydrogenated polysulfones, and the like); polyimides; polyetherimides; polyether sulfones; polyphenylene sulfides; polyether ketones; polyether ether ketones; ABS resins; polystyrenes (for example hydrogenated polystyrenes, syndiotactic, isotactic and atactic polystyrenes, hydrogenated polystyrenes such as polycyclohexyl ethylene, styrene-co-acrylonitrile, styrene-co-maleic anhydride, and the like); polybutadiene; polyacrylates (for example, polymethylmethacrylate (PMMA), methyl methacrylate-polyimide copolymers, and the like); polyacrylonitrile; polyacetals; polycarbonates; polyphenylene ethers (for example, those derived from 2,6-dimethylphenol and copolymers with 2,3,6-trimethylphenol, and the like); ethylene-vinyl acetate copolymers; polyvinyl acetate; liquid crystalline polymers; fluoropolymers such as ethylene-tetrafluoroethylene copolymer, polyvinyl fluoride, and polyvinylidene fluoride, polytetrafluoroethylene (provided that the fluoropolymer has a lower softening temperature than the fluoropolymer component described below); polyvinyl chloride, polyvinylidene chloride; and combinations comprising at least one of the foregoing polymers. The matrix polymer may generally be provided in any form, including but not limited to powders, plates, pellets, flakes, chips, whiskers, and the like.

Fluoropolymers suitable for use as the fibrillated fluoropolymer component of the disclosure are capable of being fibrillated (“fibrillatable”) during mixing with the matrix polymer, the filler, or both simultaneously. “Fibrillation” is a term of art that refers to the treatment of fluoropolymers so as to produce, for example, a “node and fibril,” network, or cage-like structure.

In one aspect, the reinforcement material (e.g., fluoropolymer, UHMW-PE) comprises fibrils having an average diameter of 5 nanometers (nm) to 2 micrometers (μm), or from about 5 nm to about 2 μm. The reinforcement material may also have an average fibril diameter of 30 nanometers to 750 nanometers, more specifically 5 nanometers to 500 nanometers. In a further example, the reinforcement material may also have an average fibril diameter of about 30 nanometers to about 750 nanometers, more specifically about 5 nanometers to about 500 nanometers. Field Emission Scanning Electron Microscopy can be employed to observe the extent of fibrillation of the reinforcement material throughout the matrix polymer in the fibrillated compositions.

Suitable fluoropolymers are described in, e.g., U.S. Pat. No. 7,557,154 and include but are not limited to homopolymers and copolymers that comprise structural units derived from one or more fluorinated alpha-olefin monomers, that is, an alpha-olefin monomer that includes at least one fluorine atom in place of a hydrogen atom. In one aspect the fluoropolymer comprises structural units derived from two or more fluorinated alpha-olefin, for example tetrafluoroethylene, hexafluoroethylene, and the like. In another aspect, the fluoropolymer comprises structural units derived from one or more fluorinated alpha-olefin monomers and one or more non-fluorinated monoethylenically unsaturated monomers that are copolymerizable with the fluorinated monomers, for example alpha-monoethylenically unsaturated copolymerizable monomers such as ethylene, propylene, butene, acrylate monomers (e.g., methyl methacrylate and butyl acrylate), vinyl ethers, (e.g., cyclohexyl vinyl ether, ethyl vinyl ether, n-butyl vinyl ether, vinyl esters) and the like. Specific examples of fluoropolymers include polytetrafluoroethylene, polyhexafluoropropylene, polyvinylidene fluoride, polychlorotrifluoroethylene, ethylene tetrafluoroethylene, fluorinated ethylene-propylene, polyvinyl fluoride, and ethylene chlorotrifluoroethylene. Combinations comprising at least one of the foregoing fluoropolymers may also be used. Polytetrafluoroethylene (PTFE) is considered especially suitable.

As is known, fluoropolymers are available in a variety of forms, including powders, emulsions, dispersions, agglomerations, and the like. “Dispersion” (also called “emulsion”) fluoropolymers are generally manufactured by dispersion or emulsion, and may comprise 25 to 60 weight percent (wt %), or about 25 wt % to 60 wt %, fluoropolymer in water, stabilized with a surfactant, wherein the fluoropolymer particles are 0.1 to 0.3 micrometers (microns, μm), or about 0.1 μm to about 0.3 μm in diameter. “Fine powder” (or “coagulated dispersion”) fluoropolymers may be made by coagulation and drying of dispersion-manufactured fluoropolymers. Fine powder fluoropolymers are generally manufactured to have a particle size of 400 to 500 μm, or about 400 μm to about 500 μm. “Granular” fluoropolymers may be made by a suspension method, and are generally manufactured in two different particle size ranges, including a median particle size of 30 to 40 μm, or about 30 μm to about 40 μm and a high bulk density product exhibiting a median particle size of 400 to 500 μm, or about 400 μm to about 500 μm. Pellets of fluoropolymer may also be obtained and cryogenically ground to exhibit the desired particle size.

A fluoropolymer may be at least partially encapsulated by an encapsulating polymer that may be the same as or different from the matrix polymer (hereinafter referred to as an “encapsulated polymer”). Without being bound by theory, it is believed that encapsulation may aid in the distribution of the fluoropolymer within the matrix, and/or compatibilize the fluoropolymer with the matrix.

Suitable encapsulating polymers accordingly include, but are not limited to, vinyl polymers, acrylic polymers, polyacrylonitrile, polystyrenes, polyolefins, polyesters, polyurethanes, polyamides, polysulfones, polyimides, polyetherimides, polyphenylene ethers, polyphenylene sulfides, polyether ketones, polyether ether ketones, acrylonitrile butadiene styrene (ABS) resins, polyethersulfones, poly(alkenylaromatic) polymers, polybutadiene, liquid crystalline polymers, polyacetals, polycarbonates, polyphenylene ethers, ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, and combinations comprising at least one of the foregoing polymers.

The encapsulating polymers may be obtained by polymerization of monomers or mixtures of monomers by methods known in the art, for example, condensation, addition polymerization, and the like. Emulsion polymerization, particularly radical polymerization may be used effectively. In one aspect, the encapsulating polymer is formed from monovinylaromatic monomers containing condensed aromatic ring structures, such as vinyl naphthalene, vinyl anthracene and the like. Examples of suitable monovinylaromatic monomers include styrene, 3-methylstyrene, 3,5-diethylstyrene, 4-n-propylstyrene, alpha-methylstyrene, alpha-methyl vinyltoluene, alpha-chlorostyrene, alpha-bromostyrene, dichlorostyrene, dibromostyrene, tetra-chlorostyrene, and the like, and combinations comprising at least one of the foregoing compounds. Styrene and/or alpha-methylstyrene may be specifically mentioned. Other useful monomers for the formation of the encapsulating polymer include monovinylic monomers such as itaconic acid, acrylamide, N-substituted acrylamide or methacrylamide, maleic anhydride, maleimide, N-alkyl-, aryl-, or haloaryl-substituted maleimide, and glycidyl (meth)acrylates. Other monomers include acrylonitrile, ethacrylonitrile, methacrylonitrile, alpha-chloroacrylonitrile, beta-chloroacrylonitrile, alpha-bromoacrylonitrile, acrylic acid, methyl (meth)acrylate, ethyl (meth)acrylate, n-butyl (meth)acrylate, t-butyl (meth)acrylate, n-propyl (meth)acrylate, isopropyl (meth)acrylate, 2-ethylhexyl (meth)acrylate, and the like, and combinations comprising at least one of the foregoing monomers.

Mixtures of the foregoing monovinylaromatic monomers and monovinylic monomers may also be used, for example mixtures of styrene and acrylonitrile (SAN). The relative ratio of monovinylaromatic and monovinylic monomers in the rigid graft phase may vary widely depending on the type of fluoropolymer, type of monovinylaromatic and monovinylic monomer(s), and the desired properties of the encapsulant. The encapsulant may generally be formed from up to 100 wt %, or up to about 100 wt %, of monovinyl aromatic monomer, specifically 30 to 100 wt %, more specifically 50 to 90 wt % monovinylaromatic monomer, with the balance being comonomer(s). In further examples, the encapsulant may generally be formed from up to about 100 wt % of monovinyl aromatic monomer, specifically about 30 to about 100 wt %, more specifically about 50 to about 90 wt % monovinylaromatic monomer, with the balance being comonomer(s).

Elastomers may also be used as the encapsulating polymer, as well as elastomer-modified graft copolymers. Suitable elastomers include, for example, conjugated diene rubbers; copolymers of a conjugated diene with less than 50 wt %, or less than about 50 wt %, of a copolymerizable monomer; olefin rubbers such as ethylene propylene copolymers (EPR) or ethylene-propylene-diene monomer rubbers (EPDM); ethylene-vinyl acetate rubbers; silicone rubbers; elastomeric C1-8 alkyl (meth)acrylates; elastomeric copolymers of C1-8 alkyl (meth)acrylates with butadiene and/or styrene; or combinations comprising at least one of the foregoing elastomers.

Examples of conjugated diene monomers that may be used are butadiene, isoprene, 1,3-heptadiene, methyl-1,3-pentadiene, 2,3-dimethyl-1,3-butadiene, 2-ethyl-1,3-pentadiene; 1,3- and 2,4-hexadienes, and the like, as well as mixtures comprising at least one of the foregoing conjugated diene monomers. Specific conjugated diene homopolymers include polybutadiene and polyisoprene.

Copolymers of conjugated diene rubbers may also be used, for example those produced by aqueous radical emulsion polymerization of a conjugated diene and up to 10 wt %, or up to about 10 wt %, of one or more monomers copolymerizable therewith.

(Meth)acrylate monomers suitable for use as an elastomeric encapsulating monomer include the cross-linked, particulate emulsion homopolymers or copolymers of C4-8 alkyl (meth)acrylates, in particular C4-6 alkyl acrylates, for example n-butyl acrylate, t-butyl acrylate, n-propyl acrylate, isopropyl acrylate, 2-ethylhexyl acrylate, and the like, and combinations comprising at least one of the foregoing monomers. Exemplary comonomers include but are not limited to butadiene, isoprene, styrene, methyl methacrylate, phenyl methacrylate, phenethylmethacrylate, N-cyclohexylacrylamide, vinyl methyl ether or acrylonitrile, and mixtures comprising at least one of the foregoing comonomers. Optionally, up to 5 wt % of a polyfunctional cross-linking comonomer may be present, for example divinylbenzene, alkylenediol di(meth)acrylates such as glycol bisacrylate, alkylenetriol tri(meth)acrylates, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, triallyl esters of phosphoric acid, and the like, as well as combinations comprising at least one of the foregoing cross-linking agents.

Suitable elastomer-modified graft copolymers may be prepared by first providing an elastomeric polymer (for example, as described above), then polymerizing the constituent monomer(s) of the rigid phase in the presence of the fluoropolymer and the elastomer to obtain the graft copolymer. The elastomeric phase may provide 5 to 95 wt % of the total graft copolymer, more specifically 20 to 90 wt %, and even more specifically 40 to 85 wt % of the elastomer-modified graft copolymer, the remainder being the rigid graft phase. In further examples, the elastomeric phase may provide about 5 to about 95 wt % of the total graft copolymer, more specifically about 20 to about 90 wt %, and even more specifically about 40 to about 85 wt % of the elastomer-modified graft copolymer, the remainder being the rigid graft phase. Depending on the amount of elastomer-modified polymer present, a separate matrix or continuous phase of ungrafted rigid polymer or copolymer may be simultaneously obtained along with the elastomer-modified graft copolymer.

Specific encapsulating polymers include polystyrene, copolymers of polystyrene, poly(alpha-methylstyrene), poly(alpha-ethylstyrene), poly(alpha-propylstyrene), poly(alpha-butylstyrene), poly(p-methylstyrene), polyacrylonitrile, polymethacrylonitrile, poly(methyl acrylate), poly(ethyl acrylate), poly(propyl acrylate), and poly(butyl acrylate), poly(methyl methacrylate), poly(ethyl methacrylate), poly(propyl methacrylate), poly(butyl methacrylate); polybutadiene, copolymers of polybutadiene with propylene, poly(vinyl acetate), poly(vinyl chloride), poly(vinylidene chloride), poly(vinylidene fluoride), poly(vinyl alcohols), acrylonitrile-butadiene copolymer rubber, acrylonitrile-butadiene-styrene (ABS), poly(C4-8 alkyl acrylate) rubbers, styrene-butadiene rubbers (SBR), EPDM rubbers, silicon rubber and combinations comprising at least one of the foregoing encapsulating polymers. A preferred fluoropolymer is polytetrafluoroethylene.

Preferably, the encapsulating polymer comprises a styrene-acrylonitrile copolymer, an acrylonitrile-butadiene-styrene copolymer, alpha-alkyl-styrene-acrylonitrile copolymer, an alpha-methylstyrene-acrylonitrile copolymer, a styrene-butadiene rubber, a methyl methacrylate copolymer, or a combination thereof. In another aspect, the encapsulating polymer comprises SAN, ABS copolymers, alpha-(C1-3)alkyl-styrene-acrylonitrile copolymers, alpha-methylstyrene-acrylonitrile (AMSAN) copolymers, SBR, and combinations comprising at least one of the foregoing. In yet another aspect the encapsulating polymer is SAN or AMSAN. A preferred fluoropolymer encapsulated by an encapsulating polymer is styrene acrylonitrile encapsulated polytetrafluoroethylene.

Suitable amounts amount of encapsulating polymer may be determined by one of ordinary skill in the art without undue experimentation, using the guidance provided herein. In one aspect, the encapsulated fluoropolymer comprises 10 to 90 weight percent (wt %), or about 10 to about 90 wt %, fluoropolymer and 90 to 10 wt %, or about 90 wt % to about 10 wt %, of the encapsulating polymer, based on the total weight of the encapsulated fluoropolymer. Alternatively, the encapsulated fluoropolymer comprises 20 to 80 wt %, or about 20 to about 80 wt %, more specifically 40 wt % to 60 wt %, or about 40 to about 60 wt % fluoropolymer, and 80 wt % to 20 wt %, or about 80 to about 20 wt %, specifically, 60 wt % or 40 wt %, or about 60 about 40 wt % encapsulating polymer, based on the total weight of the encapsulated polymer.

Additives

The disclosed compositions may include one or more other additives may be present in the compositions described herein, as desired. Exemplary additives include: one or more polymers, ultraviolet agents, ultraviolet stabilizers, heat stabilizers, antistatic agents, anti-microbial agents, anti-drip agents, radiation stabilizers, pigments, dyes, fibers, fillers, plasticizers, fibers, flame retardants, antioxidants, lubricants, wood, glass, and metals, and combinations thereof.

Exemplary polymers that can be mixed with the compositions described herein include elastomers, thermoplastics, thermoplastic elastomers, and impact additives. The compositions described herein may be mixed with other polymers such as a polyester, a polyestercarbonate, a bisphenol-A homopolycarbonate, a polycarbonate copolymer, a tetrabromo-bisphenol A polycarbonate copolymer, a polysiloxane-co-bisphenol-A polycarbonate, a polyesteramide, a polyimide, a polyetherimide, a polyamideimide, a polyether, a polyethersulfone, a polyepoxide, a polylactide, a polylactic acid (PLA), an acrylic polymer, polyacrylonitrile, a polystyrene, a polyolefin, a polysiloxane, a polyurethane, a polyamide, a polyamideimide, a polysulfone, a polyphenylene ether, a polyphenylene sulfide, a polyether ketone, a polyether ether ketone, an acrylonitrile-butadiene-styrene (ABS) resin, an acrylic-styrene-acrylonitrile (ASA) resin, a polyphenylsulfone, a poly(alkenylaromatic) polymer, a polybutadiene, a polyacetal, a polycarbonate, an ethylene-vinyl acetate copolymer, a polyvinyl acetate, a liquid crystal polymer, an ethylene-tetrafluoroethylene copolymer, an aromatic polyester, a polyvinyl fluoride, a polyvinylidene fluoride, a polyvinylidene chloride, tetrafluoroethylene, or any combination thereof.

The additional polymer can be an impact modifier, if desired. Suitable impact modifiers may be high molecular weight elastomeric materials derived from olefins, monovinyl aromatic monomers, acrylic and methacrylic acids and their ester derivatives, as well as conjugated dienes that are fully or partially hydrogenated. The elastomeric materials can be in the form of homopolymers or copolymers, including random, block, radial block, graft, and core-shell copolymers.

A specific type of impact modifier may be an elastomer-modified graft copolymer comprising (i) an elastomeric (i.e., rubbery) polymer substrate having a Tg less than 10 degrees Celsius (° C.), or less than about 10° C., less than 0° C. or less than about 0° C., less than −10° C. or less than about −10° C., or between −40° C. to −80° C. or between about −40° C. to −80° C., and (ii) a rigid polymer grafted to the elastomeric polymer substrate. Materials suitable for use as the elastomeric phase include, for example, conjugated diene rubbers, for example polybutadiene and polyisoprene; copolymers of a conjugated diene with less than about 50 wt % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁-C₈ alkyl(meth)acrylates; elastomeric copolymers of C₁-C₈ alkyl(meth)acrylates with butadiene and/or styrene; or combinations comprising at least one of the foregoing elastomers. Materials suitable for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically methyl methacrylate.

Specific impact modifiers include styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN). Exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN).

The compositions described herein may comprise an ultraviolet (UV) stabilizer for dispersing UV radiation energy. The UV stabilizer does not substantially hinder or prevent cross-linking of the various components of the compositions described herein. UV stabilizers may be hydroxybenzophenones; hydroxyphenyl benzotriazoles; cyanoacrylates; oxanilides; or hydroxyphenyl triazines. Specific UV stabilizers include poly[(6-morphilino-s-triazine-2,4-diyl)[2,2,6,6-tetramethyl-4-piperidyl) imino]-hexamethylene [(2,2,6,6-tetramethyl-4-piperidyl)imino], 2-hydroxy-4-octyloxybenzophenone (Uvinul™ 3008); 6-tert-butyl-2-(5-chloro-2H-benzotriazole-2-yl)-4-methylphenyl (Uvinul™ 3026); 2,4-di-tert-butyl-6-(5-chloro-2H-benzotriazole-2-yl)-phenol (Uvinul™ 3027); 2-(2H-benzotriazole-2-yl)-4,6-di-tert-pentylphenol (Uvinul™ 3028); 2-(2H-benzotriazole-2-yl)-4-(1,1,3,3-tetramethylbutyl)-phenol (Uvinul™ 3029); 1,3-bis[(2′-cyano-3′,3′-diphenylacryloyl)oxy]-2,2-bis-{[(2′-cyano-3′,3′-diphenylacryloyl)oxy]methyl}-propane (Uvinul™ 3030); 2-(2H-benzotriazole-2-yl)-4-methylphenol (Uvinul™ 3033); 2-(2H-benzotriazole-2-yl)-4,6-bis(1-methyl-1-phenyethyl) phenol (Uvinul™ 3034); ethyl-2-cyano-3,3-diphenylacrylate (Uvinul™ 3035); (2-ethylhexyl)-2-cyano-3,3-diphenylacrylate (Uvinul™ 3039); N,N′-bisformyl-N,N′-bis (2,2,6,6-tetramethyl-4-piperidinyl)hexamethylenediamine (Uvinul™ 4050H); bis-(2,2,6,6-tetramethyl-4-pipieridyl)-sebacate (Uvinul™ 4077H); bis-(1,2,2,6,6-pentamethyl-4-piperdiyl)-sebacate+methyl-(1,2,2,6,6-pentamethyl-4-piperidyl)-sebacate (Uvinul™ 4092H); or combinations thereof. Other UV stabilizers include Cyasorb 5411, Cyasorb UV-3638, Uvinul 3030, and/or Tinuvin 234.

The compositions described herein may comprise heat stabilizers. Exemplary heat stabilizer additives include, for example, organophosphites such as triphenyl phosphite, tris-(2,6-dimethylphenyl)phosphite, tris-(mixed mono-and di-nonylphenyl)phosphite, or the like; phosphonates such as dimethylbenzene phosphonate or the like; phosphates such as trimethyl phosphate, or the like; or combinations thereof.

The compositions described herein may comprise an antistatic agent. Examples of monomeric antistatic agents may include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents may include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example PELESTAT™ 6321 (Sanyo) or PEBAX™ M1H1657 (Atofina), IRGASTAT™ P18 and P22 (Ciba-Geigy). Other polymeric materials may be used as antistatic agents are inherently conducting polymers such as polyaniline (commercially available as PANIPOL™ EB from Panipol), polypyrrole and polythiophene (commercially available from Bayer), which retain some of their intrinsic conductivity after melt processing at elevated temperatures. Carbon fibers, carbon nanofibers, carbon nanotubes, carbon black, or a combination comprising at least one of the foregoing may be included to render the compositions described herein electrostatically dissipative.

The compositions described herein may comprise a radiation stabilizer, such as a gamma-radiation stabilizer. Exemplary gamma-radiation stabilizers include alkylene polyols such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; cycloalkylene polyols such as 1,2-cyclopentanediol, 1,2-cyclohexanediol, and the like; branched alkylenepolyols such as 2,3-dimethyl-2,3-butanediol (pinacol), and the like, as well as alkoxy-substituted cyclic or acyclic alkanes. Unsaturated alkenols are also useful, examples of which include 4-methyl-4-penten-2-ol, 3-methyl-pentene-3-ol, 2-methyl-4-penten-2-ol, 2,4-dimethyl-4-penten-2-ol, and 9 to decen-1-ol, as well as tertiary alcohols that have at least one hydroxy substituted tertiary carbon, for example 2-methyl-2,4-pentanediol (hexylene glycol), 2-phenyl-2-butanol, 3-hydroxy-3-methyl-2-butanone, 2-phenyl-2-butanol, and the like, and cyclic tertiary alcohols such as 1-hydroxy-1-methyl-cyclohexane. Certain hydroxymethyl aromatic compounds that have hydroxy substitution on a saturated carbon attached to an unsaturated carbon in an aromatic ring can also be used. The hydroxy-substituted saturated carbon can be a methylol group (—CH₂OH) or it can be a member of a more complex hydrocarbon group such as —CR²⁴HOH or —CR²⁴₂OH wherein R²⁴ is a complex or a simple hydrocarbon. Specific hydroxy methyl aromatic compounds include benzhydrol, 1,3-benzenedimethanol, benzyl alcohol, 4-benzyloxy benzyl alcohol and benzyl alcohol. 2-Methyl-2,4-pentanediol, polyethylene glycol, and polypropylene glycol are often used for gamma-radiation stabilization.

The term “pigments” means colored particles that are insoluble in the resulting compositions described herein. Exemplary pigments include titanium oxide, carbon black, carbon nanotubes, metal particles, silica, metal oxides, metal sulfides or any other mineral pigment; phthalocyanines, anthraquinones, quinacridones, dioxazines, azo pigments or any other organic pigment, natural pigments (madder, indigo, crimson, cochineal, etc.) and mixtures of pigments. The pigments may represent from 0.05% to 15%, or from about 0.05% to about 15%, by weight relative to the weight of the overall composition.

The term “dye” refers to molecules that are soluble in the compositions described herein and that have the capacity of absorbing part of the visible radiation.

Exemplary fibers include glass fibers, carbon fibers, polyester fibers, polyamide fibers, aramid fibers, cellulose and nanocellulose fibers or plant fibers (linseed, hemp, sisal, bamboo, etc.) may also be envisaged. It should be understood that choice of a fiber may depend on the user's needs and other process parameters; the inclusion of fibers is optional and fibers need not be present in all aspects.

Pigments, dyes or fibers capable of absorbing radiation may be used to ensure the heating of an article based on the compositions described herein when heated using a radiation source such as a laser, or by the Joule effect, by induction or by microwaves. Such heating may allow the use of a process for manufacturing, transforming, or recycling an article made of the compositions described herein.

Suitable fillers for the compositions described herein include: silica, clays (including nanoclays), calcium carbonate, carbon black, kaolin, and whiskers. Other possible fillers include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents. Fillers may be in platelet form.

Plasticizers, lubricants, and mold release agents can be included. Mold release agent (MRA) will allow the material to be removed quickly and effectively. Mold releases can reduce cycle times, defects, and browning of finished product. There is considerable overlap among these types of materials, which may include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate (PETS), and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, i.e., methyl stearate and polyethylene-polypropylene glycol copolymer in a suitable solvent; waxes such as beeswax, montan wax, paraffin wax, or the like.

Various types of flame retardants can be utilized as additives. In one aspect, the flame retardant additives include, for example, flame retardant salts such as alkali metal salts of perfluorinated C₁-C₁₆ alkyl sulfonates such as potassium perfluorobutane sulfonate (Rimar salt), potassium perfluoroctane sulfonate, tetraethylammonium perfluorohexane sulfonate, potassium diphenylsulfone sulfonate (KSS), and the like, sodium benzene sulfonate, sodium toluene sulfonate (NATS) and the like; and salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complex such as Li₃AlF₆, BaSiF₆, KBF₄, K₃AlF₆, KAF₄, K₂SiF₆, and/or Na₃AlF₆ or the like. Rimar salt and KSS and NATS, alone or in combination with other flame retardants, are particularly useful in the compositions disclosed herein. In certain aspects, the flame retardant does not contain bromine or chlorine.

The flame retardant additives may include organic compounds that include phosphorus, bromine, and/or chlorine. In certain aspects, the flame retardant is not a bromine or chlorine containing composition. Non-brominated and non-chlorinated phosphorus-containing flame retardants can include, for example, organic phosphates and organic compounds containing phosphorus-nitrogen bonds. Exemplary di- or polyfunctional aromatic phosphorus-containing compounds include resorcinol tetraphenyl diphosphate (RDP), the bis(diphenyl) phosphate of hydroquinone and the bis(diphenyl) phosphate of bisphenol-A, respectively, their oligomeric and polymeric counterparts, and the like. Other exemplary phosphorus-containing flame retardant additives include phosphonitrilic chloride, phosphorus ester amides, phosphoric acid amides, phosphonic acid amides, phosphinic acid amides, tris(aziridinyl) phosphine oxide, polyorganophosphazenes, and polyorganophosphonates.

Some suitable polymeric or oligomeric flame retardants include: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; 2,2-bis-(3,5-dichloro-4-hydroxyphenyl)-propane; and 2,2-bis-(3-bromo-4-hydroxyphenyl)-propane. Other flame retardants include: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

The flame retardant optionally is a non-halogen based metal salt, e.g., of a monomeric or polymeric aromatic sulfonate or mixture thereof. The metal salt is, for example, an alkali metal or alkali earth metal salt or mixed metal salt. The metals of these groups include sodium, lithium, potassium, rubidium, cesium, beryllium, magnesium, calcium, strontium, francium and barium. Examples of flame retardants include cesium benzenesulfonate and cesium p-toluenesulfonate. See e.g., U.S. Pat. No. 3,933,734, EP 2103654, and US2010/0069543A1, the disclosures of which are incorporated herein by reference in their entirety.

Another useful class of flame retardant is the class of cyclic siloxanes having the general formula [(R)₂SiO]_{y} wherein R is a monovalent hydrocarbon or fluorinated hydrocarbon having from 1 to 18 carbon atoms and y is a number from 3 to 12. Examples of fluorinated hydrocarbon include, but are not limited to, 3-fluoropropyl, 3,3,3-trifluoropropyl, 5,5,5,4,4,3,3-heptafluoropentyl, fluorophenyl, difluorophenyl and trifluorotolyl. Examples of suitable cyclic siloxanes include, but are not limited to, octamethylcyclotetrasiloxane, 1,2,3,4-tetramethyl-1,2,3,4-tetravinylcyclotetrasiloxane, 1,2,3,4-tetramethyl-1,2,3,4-tetraphenylcyclotetrasiloxane, octaethylcyclotetrasiloxane, octapropylcyclotetrasiloxane, octabutylcyclotetrasiloxane, decamethylcyclopentasiloxane, dodecamethylcyclohexasiloxane, tetradecamethylcycloheptasiloxane, hexadecamethylcyclooctasiloxane, eicosamethylcyclodecasiloxane, octaphenylcyclotetrasiloxane, and the like. A particularly useful cyclic siloxane is octaphenylcyclotetrasiloxane.

Exemplary antioxidant additives include organophosphites such as tris(nonyl phenyl)phosphite, tris(2,4-di-t-butylphenyl)phosphite (“IRGAFOS 168” or “−168”), bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

The choice of additives may depend on the composition of particular materials being used in a given particulate composition, as certain additives may be better suited for some applications than others. Those of ordinary skill in the art will be able to determine the optimal additive combination for a given application.

Exemplary Aspects

Without being bound to any particular theory, fibrillated reinforcement material may act to “bridge” adjacent layers of additively-manufactured material made using the disclosed compositions. Without being bound to any particular theory, these bridging fibrils may act to reinforce or otherwise strengthen the interface between adjacent layers. This represents an improvement over existing additively-manufactured materials, as layer-layer interfaces have historically been points of failure in additively-manufactured materials.

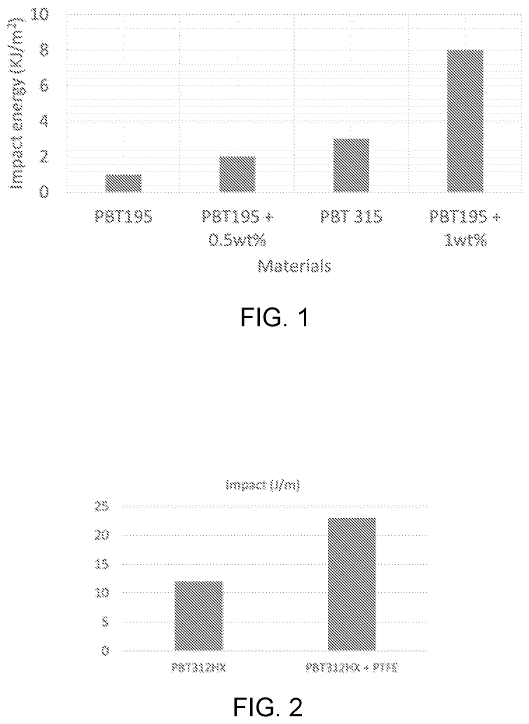

FIG. 1 provides impact strength (unnotched Izod) data for materials made with matrix material (PBT195 and PBT315) and corresponding materials made with fibrillated PTFE present at 0.5 and 1.0 wt %. As shown, the presence of the fibrillated PTFE gives rise to noticeable improvement in impact strength. The tested parts were made using selective laser sintering (SLS), and the testing was according to the ASTM D256 standard. The print orientation was in the X-direction, with a bed temperature of 210° C. and a combination of laser power, speed, hatch distance and layer thickness are chosen so that the final temperature in the printed part was above the melting point of PBT (approximately 225° C.) but below the melting point of PTFE (approximately 335° C.).

FIG. 2 provides unnotched Izod impact strength data for materials made with a matrix material (PBT312) and corresponding materials made with 1.0 wt % fibrillated PTFE. The tested samples were made using SLS and were tested in accordance with IS0527-2. The print orientation was in the X-direction, with a bed temperature of 210° C. and a combination of laser power, speed, hatch distance and layer thickness are chosen so that the final temperature in the printed part was above the melting point of PBT (approximately 225° C.) but below the melting point of PTFE (approximately 335° C.). As shown, sample including fibrillated PTFE exhibited an improvement in impact strength of about 100%. Tensile properties (tensile modulus and flexural modulus) of the samples were also tested in accordance with IS0527-2 and did not exhibit any substantial changes.

Again, without being bound to any particular theory, an article may comprise within a plurality of fibrils, the fibrils being in various orientations. Not all fibrils need be oriented in the same direction; fibrils may have their major axes lie along different directions. A single particle may comprise two (or more) domains of oriented reinforcement material (e.g., fibrils), wherein the reinforcement materials in a given domain share a common orientation (or are oriented similar to one another), and wherein different domains of oriented reinforcement material have different orientations from one another.

Further Aspects

Aspect 1. A particulate composition, comprising, consisting of, or consisting essentially of a population of polymeric particles comprising a thermoplastic matrix polymer and a plurality of fibrillated reinforcement material regions dispersed within the thermoplastic matrix polymer, the reinforcement material being present in the particulate composition at from about 0.01 wt % to about 10 wt % as measured against the weight of the particulate composition, and the population of polymeric particles having a number average diameter in the range of from about 10 to about 150 micrometers. The thermoplastic matrix polymer suitably has a melting temperature or, where applicable, a Tg, that is below the melting temperature or Tg (where applicable) of the reinforcement material.

In some aspects, the fibrillated reinforcement regions are not oriented relative to one another, i.e. they are essentially randomly oriented. In some non-limiting aspects, the reinforcement material regions may define major axes, the major axes differing from one another by less than 90 degrees, e.g., from about 1 to about 90 degrees, from about 5 to about 85 degrees, from about 10 to about 80 degrees, from about 15 to about 75 degrees, from about 20 to about 70 degrees, from about 25 to about 65 degrees, from about 30 to about 60 degrees, or even by about 45 degrees. The axes may differ from one another by about, e.g., 25, 30, 35, 40, 45, 50, 55, 60, 65, 70, 75, 80, 85, or even about 90 degrees.

Aspect 2. The particulate composition of aspect 1, wherein the population of polymeric particles may have a D50 of from about 30 to about 80 micrometers, e.g., about 30, 40, 50, 60, 70, or even about 80 micrometers. By Dv50 is meant the median diameter or the medium value of the particle size distribution; i.e., the value of the particle diameter at 50% in the cumulative distribution. As one example, if Dv50=10 micrometers, then 50% of the particles in the sample are larger than 10 micrometers, and 50% are smaller than 10 micrometers.

Aspect 3. The particulate composition of any of aspects 1-2, wherein the thermoplastic matrix polymer comprises a polyalkylene terephthalate, a polyalkylene naphthalate, poly(phenylene oxide), polycarbonate, poly(styrene), poly(amide), a polyolefin, or any combination thereof. The thermoplastic composition may comprise amorphous regions, crystalline regions, or both.

Aspect 4. The particulate composition of aspect 3, wherein the polyalkylene terephthalate comprises polybutylene terephthalate.

Aspect 5. The particulate composition of any of aspects 1-4, wherein the reinforcement material is present in the particulate composition at from about 0.25 wt % to about 3 wt % as measured against the weight of the particulate composition.

Aspect 6. The particulate composition of any of aspects 1-5, wherein the plurality of fibrillated reinforcement material regions comprises a first group of fibrillated reinforcement material regions having major axes that are oriented to within about 20 degrees of one another and a second group of oriented reinforcement material regions having major axes that are oriented to within about 20 degrees of one another.

Aspect 7. The particulate composition of aspect 6, wherein the first group of fibrillated reinforcement material regions having major axes defines a first average major axis, wherein the second group of fibrillated reinforcement material regions having major axes defines a second average major axis, and wherein the first and second average major axes differ from one another by at least about 10 degrees.

Aspect 8. The particulate composition of any of aspects 1-7, wherein the reinforcement material comprises a polyolefin or a fluoropolymer.

Aspect 9. The particulate composition of any of aspects 1-8, wherein the reinforcement material comprises polytetrafluoroethylene, UHMW-PE, or any combination thereof. UHMW-PE may have a molecular weight in the range of from about 1 to about 10 million grams/mole, e.g., about 1 to about 10 million grams/mole, about 2 to about 9 million grams/mole, about 3 to about 8 million grams/mole, about 4 to about 7 million grams/mole, about 5 to about 6 million grams/mole, about 1 to about 2 million grams/mole, about 1 to about 3 million grams/mole, about 1 to about 4 million grams/mole, about 2 to about 3 million grams/mole, or about 3 to about 4 million grams/mole, or about 1, 2, 3, 4, or even about 5 million grams/mole.

In some aspects of the disclosed materials, the plurality of fibrillated reinforcement material regions in a particle may comprise a first group of oriented reinforcement material regions having major axes that are oriented to within about 20 degrees of one another and a second group of oriented reinforcement material regions having major axes that are oriented to within about 20 degrees of one another. In some aspects, 50% or more (e.g., 50, 55, 60, 65, 70, 75, 80, 85, 90, 95, or more than 95%) of the major axes of the oriented reinforcement material regions are oriented within about 20 degrees of one another. In some aspects, the major axes are oriented to be apart from one another by at least about 10 degrees, at least about 20 degrees, at least about 30 degrees, at least about 40 degrees, at least about 50 degrees, at least about 60 degrees, at least about 70 degrees, at least about 80 degrees, or even at least about 90 degrees.

Aspect 10. The particulate composition of any of aspects 1-9, wherein the composition has an unnotched Izod impact strength, as determined in accordance with ASTM D256, that is at least about 50% higher than a substantially similar composition that does not include the fibrillated reinforcement material. In some aspects the composition has an unnotched Izod impact strength that is at least about 75% higher, or at least about 100% higher, than a substantially similar composition that does not include the fibrillated reinforcement material. As used herein, a “substantially similar composition” is a composition that includes the same types and amounts of polymeric materials (and other additives if present) as the particulate composition, and a composition that is made in the same way as the particulate composition, but the substantially similar composition does not include the recited component (in this case the fibrillated reinforcement material). In other words, the substantially similar composition is otherwise identical to the recited particulate composition but for the absence of the fibrillated reinforcement composition.

Aspect 11. A method, comprising, consisting of, or consisting essentially of additively manufacturing at least a portion of an article, using a particulate composition according to any of aspects 1-10.

Although additive manufacturing techniques are known to those in the art, the present disclosure will provide some background on such techniques for convenience.

In some additive manufacturing techniques, a plurality of layers (of particulate composition, e.g., that according to the present disclosure) is formed in a preset pattern by an additive manufacturing process. “Plurality” as used in the context of additive manufacturing includes 2 or more layers. The maximum number of layers can vary greatly, determined, for example, by considerations such as the size of the article being manufactured, the technique used, the capabilities of the equipment used, and the level of detail desired in the final article. For example, 20 to 100,000 layers can be formed, or 50 to 50,000 layers can be formed.

As used herein, “layer” is a term of convenience that includes any shape, regular or irregular, having at least a predetermined thickness. In some aspects, the size and configuration of two dimensions are predetermined, and on some aspects, the size and shape of all three dimensions of the layer is predetermined. The thickness of each layer can vary widely depending on the additive manufacturing method. In some aspects the thickness of each layer as formed differs from a previous or subsequent layer. In some aspects, the thickness of each layer is the same. In some aspects, the thickness of each layer as formed is 0.05 millimeters (mm) (50 micrometers) to 5 mm.

The preset pattern can be determined from a three-dimensional digital representation of the desired article as is known in the art and described in further detail below.

Any additive manufacturing process can be used, provided that the process allows formation of at least one layer of a thermoplastic material that is fusible to the next adjacent layer. The plurality of layers in the predetermined pattern are fused to provide the article. Any method effective to fuse the plurality of layers during additive manufacturing can be used. In some aspects, the fusing occurs during formation of each of the layers. In some aspects the fusing occurs while subsequent layers are formed, or after all layers are formed.

The disclosed technology may include methods of forming three-dimensional objects. These methods may include depositing a layer of thermoplastic material (e.g., a material according to the disclosed compositions, e.g., aspects 1-10) through a nozzle onto a platform to form a deposited layer. A user may then deposit subsequent layers onto the first deposited layer and repeat the preceding steps to form the three-dimensional object. A related apparatus for forming such three-dimensional objects may comprise a platform configured to support the three-dimensional object.

Aspect 12. The method of aspect 11, wherein the additively manufacturing comprises selective laser sintering (SLS), high speed sintering, jet fusion, or any combination thereof. The disclosed particulate compositions may be used in a variety of additive manufacturing processes, e.g., SLS, high speed sintering, so-called jet fusion (involving deposition of a fusing agent and a detailing agent onto a layer of powder before a set of infrared lamps fuses the layer), and the like.

Aspect 13. An additively manufactured article, the article being made according to any of aspects 12-13.

Aspect 14. An additive-manufactured article, comprising: a plurality of layers, the layers being formed from a particulate composition according to any of aspects 1-10.

Aspect 15. The additive-manufactured article of aspect 14, wherein a plurality of reinforcement material regions bridge two of the plurality of layers.

An additive-manufactured article according to the present disclosure may be characterized as (a) having a modulus of above the modulus of a corresponding additive-manufactured article formed from a corresponding particulate composition lacking the reinforcement material and (b) having an unnotched Izod impact strength that is greater than that of the corresponding additive-manufactured article.

An additive-manufactured article according to the present disclosure may have a modulus of above and also greater than the modulus of the bulk thermoplastic matrix polymer. In some aspects, the additive-manufactured article according to the present disclosure has a modulus that is about 1.5, 2, 2.5, 3, 3.5, 4, 4.5, 5, 5.5, or even about 6 times the modulus of the bulk thermoplastic matrix polymer.

In an additive-manufactured article, the oriented reinforcement materials may be of random orientation within the article. Without being bound to any particular theory, this may be the result of the random orientation of particulates when the particulates are swept into the working area of the additive manufacturing system and then heated and further processed so as to form the additive manufactured article.

1. A particulate composition, comprising:
a population of polymeric particles comprising a thermoplastic matrix polymer and a plurality of fibrillated reinforcement material regions comprising a fibrillated reinforcement material dispersed within the thermoplastic matrix polymer,
the fibrillated reinforcement material being present in the particulate composition at from about 0.01 wt % to about 10 wt % as measured against the weight of the particulate composition,
the population of polymeric particles having a number average diameter in a range of from about 10 micrometers (μm) to about 150 μm, and
the melting temperature or Tg of the thermoplastic matrix polymer, whichever is higher, being below the melting temperature or Tg, whichever is lower, of the fibrillated reinforcement material.

2. The particulate composition of claim 1, wherein the population of polymeric particles has a Dv50 of from about 30 to about 80 micrometers.

3. The particulate composition of claim 1, wherein the thermoplastic matrix polymer comprises a polyalkylene terephthalate, a polyalkylene naphthalate, poly(phenylene oxide), polycarbonate, poly(styrene), poly(amide), a polyolefin, or any combination thereof.

4. The particulate composition of claim 3, wherein the polyalkylene terephthalate comprises polybutylene terephthalate.

5. The particulate composition of claim 1, wherein the fibrillated reinforcement material is present in the particulate composition at from about 0.25 wt % to about 3 wt % as measured against the weight of the particulate composition.

6. The particulate composition of claim 1, wherein the fibrillated reinforcement material comprises polytetrafluoroethylene, ultra-high molecular weight polyethylene, or any combination thereof.

7. The particulate composition of claim 1, wherein the fibrillated reinforcement material comprises polytetrafluoroethylene, and wherein the thermoplastic matrix polymer comprises poly(butylene terephthalate).

8. The particulate composition of claim 1, wherein the composition has an unnotched Izod impact strength, as determined in accordance with ASTM D256, that is at least about 50% higher than a substantially similar composition that does not include the fibrillated reinforcement material.

9. The particulate composition of claim 1, wherein the composition has an unnotched Izod impact strength, as determined in accordance with ASTM D256, that is at least about 100% higher than a substantially similar composition that does not include the fibrillated reinforcement material.

10. A method, comprising: additively manufacturing at least a portion of an article, using a particulate composition of claim 1.

11. The method of claim 10, wherein the additively manufacturing comprises selective laser sintering, high speed sintering, or jet fusion.

12. An additive-manufactured article, comprising:
a plurality of layers, the layers being formed from a particulate composition of claim 1.

13. The additive-manufactured article of claim 12, wherein a plurality of reinforcement material regions bridge two of the plurality of layers.
